(19) United States
(12) Patent Application Publication
(10) Pub. No.: US 2013/0074590 A1
(43) Pub. Date: Mar. 28, 2013

(54) Method For Determining The State Of A Reducing Agent In A Reducing Agent Tank

(71) Applicants: Thomas Bertow, Nurnberg (DE); Hermann Ketterl, Stephansposching (DE)

(72) Inventors: Thomas Bertow, Nurnberg (DE); Hermann Ketterl, Stephansposching (DE)

(73) Assignee: Continental Automotive GmbH, Hannover (DE)

(21) Appl. No.: 13/512,294

(22) PCT Filed: Oct. 18, 2010
(86) PCT No.: PCT/EP2010/065643

§ 371 Date: Oct. 2, 2012

(30) Foreign Application Priority Data
Nov. 26, 2009 (DE) 102009055738.5

(51) Int. Cl. G01M 15/10

(52) U.S. Cl. CPC G01M 15/10
USPC 73/114.71

(57) ABSTRACT

A method for determining the state of a reducing agent in a reducing agent tank. The reducing agent is used for exhaust gas after-treatment of exhaust gas generated by an internal combustion engine. To inform the control unit of an internal combustion engine regarding the quality of the reducing agent in the reducing agent tank the method includes determining and recording the filling and extracting volumes of the reducing agent from the reducing agent tank by a fill level sensor, determining and recording the temperature of the reducing agent in the reducing agent tank by at least one temperature sensor over the entire service life of the exhaust gas after-treatment unit, determining and recording the distribution velocity of ultrasonic waves in the reducing agent by an ultrasonic transmitter and ultrasonic receiver, determining the state of a reducing agent from the parameters.

### CROSS REFERENCE TO RELATED APPLICATION

This is a U.S. national stage of application No. PCT/EP2010/065643, filed on 18 Oct. 2010. Priority is claimed on German, Application No.: 10 2009 055 738.5 filed 26 Nov. 2009 the content of which is/are incorporated here by reference.

### BACKGROUND OF THE INVENTION

The present invention relates to a method for determining the state of a reducing agent in a reducing agent tank, wherein the reducing agent can be used for exhaust gas post-treatment of the exhaust gases generated by an internal combustion engine.

### Description of Prior Art

For the reduction of nitrogen oxide emissions of motor vehicles, exhaust gas post-treatment units in which a reducing agent (urea/water solution) is stored in a reducing agent tank is fed to the exhaust section of an internal combustion engine are known from the prior art. Particularly motor vehicles which are operated with diesel fuel give rise to increased nitrogen oxide (NOx) emissions that can be reduced by injecting reducing agent into the exhaust section. To reduce the nitrogen oxide emissions a Selective Catalytic Reduction (SCR) method is used. Since the reducing agent is consumed over the long term by the injection into the exhaust section of the internal combustion engine in the region of an SCR catalytic converter, from time to time fresh reducing agent has to be refilled into the reducing agent tank. The reduction of nitrogen oxides (NOx) is possible here only if the urea/water solution is of a sufficiently high quality. In this context, reducing agents are generally urea/water solutions with a certain quality level, i.e. a certain mixture ratio between urea and water. These urea/water solutions are known by the trade name AdBlue, Urea, Denoxium, and AUS 32.

Sufficient reduction of nitrogen oxide is possible only if the reducing agent solution is of a sufficiently high quality. In contrast, when the reducing agent tank is filled with a reducing agent solution of a relatively low quality, reduction of the nitrogen oxides in the exhaust gas of the internal combustion engine is not sufficiently ensured. Owing to legal requirements, vehicles of a modern design must have an on-board diagnostic unit that monitors all the exhaust-gas-relevant systems of the vehicle (OBD2). When the reducing agent tank is filled with a reducing agent solution of a relatively low quality, a general fault of the exhaust gas post-treatment unit is detected by an on-board diagnostic unit. However, this fault can have various causes, for example it may occur if a component in the diagnostic system is defective, the SCR catalytic converter has aged, nitrogen oxide sensor drift has occurred, or even if an incorrect or low-quality reducing agent has been filled in. The requirement for precise detailing of the fault, which is prescribed by the laws of various states, cannot be satisfied with a general fault message.

### SUMMARY OF THE INVENTION

It is an object of one embodiment of the present invention to specify a method with which precise information about the quality of the reducing agent used can be obtained.

For a method of the type mentioned at the beginning, one embodiment of the invention achieves the object by the following method:
determining and recording the filling and extracting quantities of the reducing agent from the reducing agent tank by a filling level sensor over the entire service life of the exhaust gas post-treatment unit,
determining and recording the temperature of the reducing agent in the reducing agent tank by means of at least one temperature sensor over the entire service life of the exhaust gas post-treatment unit,
determining and recording the propagation speed of ultrasonic waves in the reducing agent by an ultrasonic transmitter and ultrasonic receiver, and
determining the state of a reducing agent from the abovementioned variables in a control unit.

The recording of the characteristic variables, relevant for the reducing agent, over the entire life cycle of the exhaust gas post-treatment unit permits precise determination of the quality of the reducing agent at any time. This ensures effective exhaust gas post-treatment, thereby making a contribution to protection of the environment.

According to one embodiment, the conductivity of the reducing agent is determined by a conductivity sensor and recorded in a memory. The conductivity of the reducing agent is also an important reference point for assessing the quality of the reducing agent.

According to one embodiment it is possible to provide that in addition the conductivity of the replenished reducing agent by a conductivity sensor arranged in the filler connector of the reducing agent tank is determined and is recorded in a memory. In particular the conductivity of the replenished reducing agent is an important reference point for assessing the quality of the reducing agent since malicious or negligent incorrect refilling of the reducing agent tank may be carried out by the operator of the vehicle. This incorrect refilling can be detected particularly effectively in the region of the filler connector.

According to one embodiment, the NOx concentration in the exhaust gas of the internal combustion engine is determined by at least one an NOx sensor and recorded in a memory. The NOx concentration in the exhaust gas is a direct measure of the effectiveness of the exhaust gas purification in the SCR catalytic converter and therefore also of the quality of the reducing agent. For example, it is conceivable to position an NOx sensor upstream of the SCR catalytic converter and to position an NOx sensor downstream of the SCR catalytic converter and to compare the measured values of the two NOx sensors. The results of this comparison provide direct information about the quality of the exhaust gas purification by the reducing agent in the SCR catalytic converter. For this purpose, the theoretically necessary quantity of the reducing agent to completely remove the NOx concentration in the exhaust gas compared to the actually required quantity of the reducing agent to completely remove the NOx concentration in the exhaust gas can be determined by at least one NOx sensor and be recorded in a memory.

In a subsequent refinement, it is determined and recorded in the memory whether, when and/or for what time period the reducing agent has been present in a solid, liquid or partially liquid physical state. Particularly freezing of the reducing agent can influence its quality, and this should be reliably detected.

### BRIEF DESCRIPTION OF THE DRAWINGS

An exemplary embodiment of the invention is explained below in more detail with reference to a drawing.

FIG. 1 is an assembly including a system for determining a state of a reducing agent.

### DETAILED DESCRIPTION OF THE PREFERRED EMBODIMENTS

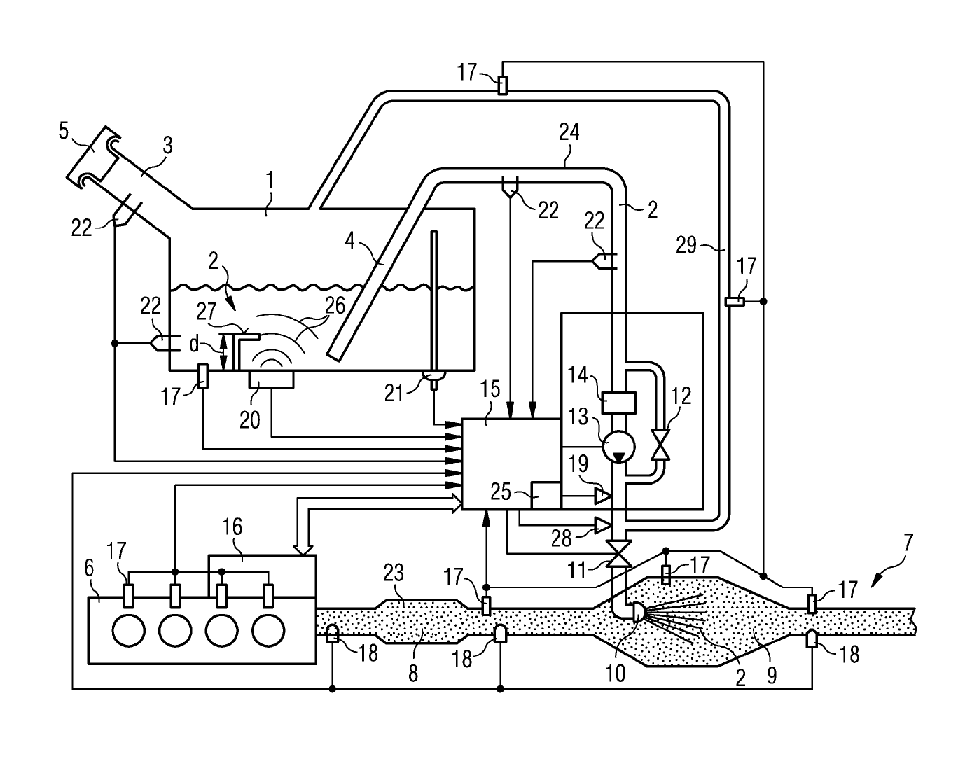

FIG. 1 shows an internal combustion engine 6 having an exhaust section 7. Internal combustion engines, in particular diesel engines, generate a considerable quantity of environmentally damaging nitrogen oxides NOx. The nitrogen oxides NOx, which are output by the internal combustion engine 6, are output into the environment with the exhaust gas 23 via the exhaust section 7 if suitable measures for reducing the nitrogen oxides NOx are not taken in the exhaust section.

For exhaust gas purification, the exhaust section has an exhaust gas post-treatment unit including catalytic converters and further components which will be described below. First, an oxidation catalytic converter 8 is provided that is followed by what is referred to as an SCR catalytic converter for removing the nitrogen oxides NOx contained in the exhaust gas. SCR is here an abbreviation meaning Selective Catalytic Reduction. In the SCR catalytic converter 9 the nitrogen oxides NOx are converted into harmless nitrogen N₂ and water H₂O. For this purpose, a urea/water solution, which is also referred to as reducing agent 2, is injected into the SCR catalytic converter 9 via nozzle 10. The reducing agent 2 then reacts with the nitrogen oxides NOx to form the harmless components H₂O and N₂.

To bring about an optimum reaction between NOx and the urea/water solution, a quantity of urea, which is adapted to the NOx concentration in the exhaust gas 23, must be injected into the SCR catalytic converter 9 via the nozzle 10. For this purpose it is important to know the precise composition of the reducing agent 2 from water and urea. Since only small quantities of reducing agent 2 have to be injected into the SCR catalytic converter, and frequent refilling of a motor vehicle with reducing agent 2 is to be avoided, a specific quantity of reducing agent 2 remains in the reducing agent tank 1 over a relatively long time period. In the reducing agent tank 1, the reducing agent 2 ages over time, wherein, for example, organic substances in the reducing agent 2 are precipitated or the reducing agent freezes temporarily owing to low temperatures (below −11° C.) and as a result possibly loses its composition and quality. High temperatures can also damage the reducing agent 2, in particular the evaporation of water from the reducing agent 2 gives rise to a changed mixture ratio between the urea and the water. In addition, the urea can crystallize out under the effect of oxygen and be precipitated as a crystalline deposit in the reducing agent tank 1. Furthermore, it is conceivable for the reducing agent tank 1 to be intentionally or negligently filled with a low-quality reducing agent 2 or even just with water. If the quality of the reducing agent 2 is reduced owing to such events, this must be detected in order to continue to ensure optimum purification of the exhaust gas 23. In the case of a reduced urea concentration in the reducing agent 2, it would be necessary to inject an increased quantity of reducing agent 2 into the SCR catalytic converter 9. If it is no longer possible to meaningfully remove NOx from the exhaust gas 3 at all owing to the reducing agent tank 1 having been completely refilled incorrectly, a corresponding fault signal must be issued in the cockpit of the vehicle driver and/or a corresponding entry must be made in the fault memory of the on-board diagnostic unit (OLD).

FIG. 1 shows a multiplicity of sensors for monitoring the quality of the reducing agent. The reducing agent tank contains a conductivity sensor 22 at the filler connector 3. The conductivity sensor 22 measures the quality of the filled-in reducing agent 2 during a filling process. Furthermore, the tank cover 5, the opening of which would allow the conductivity measurement by the conductivity sensor 22 in the filler connector 3 to be initiated, can be seen on the filler connector 3. A conductivity sensor 22 and a temperature sensor 17 and a filling level sensor 21 are also formed in the reducing agent tank 1. The conductivity of the reducing agent 2 present in the reducing agent tank 1 can be detected continuously with the conductivity sensor 22. Furthermore, by the temperature sensor 17, the temperature of the reducing agent 2, which is present in the reducing agent tank 1, can be detected continuously. In particular, by the temperature sensor 17, it is possible to detect whether the reducing agent 2 in the reducing agent tank 1 has frozen, is present in the liquid state, or has become too hot. The filling level sensor 21 permits the filling level of the reducing agent 2 in the reducing agent tank 1 to be measured over the entire service life of the exhaust gas post-treatment unit. All the detected data relating to the state of the reducing agent 2 are stored in an electronic memory 25.

In addition, an ultrasonic transmitter/receiver, with which the speed of sound of an ultrasonic wave at a specific frequency of the reducing agent 2 located in the reducing agent tank 1 can be determined, can be seen on the reducing agent tank 1. For this purpose it is advantageous to mount a reflector surface 27 at a predetermined distance d in front of the ultrasonic transmitter 20. Since the distance d between the ultrasonic transmitter/receiver 20 is known and the wavelength of the ultrasonic pulse emitted by the ultrasonic transmitter 20 is also known, the speed of sound of the ultrasonic pulse in the reducing agent 2 can be determined. The quality and, in particular, the composition of the reducing agent 2 in the reducing agent tank 1 can be inferred by this ultrasonic speed in the reducing agent 2. The ultrasonic speed of an ultrasonic pulse with a specific frequency in pure water differs considerably here from the ultrasonic speed of an ultrasonic wave with a specific frequency in a twenty percent, fifty percent or ninety percent reducing agent solution.

An extraction pipe 4 can be seen in the reducing agent tank 1, said extraction pipe 4 leading with a pipe 24 to a filter 14 and a pump 13 which pumps the reducing agent 2 from the reducing agent tank 1 to the SCR nozzle 10 in the SCR catalytic converter via an SCR valve 11. The quantity of the injected reducing agent 2 can be regulated by the SCR valve 11. For this purpose, the SCR valve 11 is electrically connected to the SCR control unit 15. The SCR control unit 15 actuates the SCR valve 11. The SCR control unit 15 receives a multiplicity of signals from the following sensors:
NOx sensors 18 arranged in the exhaust section 7 directly downstream of the internal combustion engine 6, between the oxidation catalytic converter 8 and the SCR catalytic converter 9, and downstream of the SCR catalytic converter 9 at the output of the exhaust section 7,
temperature sensors 17 arranged directly downstream of the internal combustion engine 6 and/or downstream of the oxidation catalytic converter 8 and/or in the SCR catalytic converter 9 and/or downstream of the SCR catalytic converter 9 and/or in the return line 29,
conductivity sensors arranged in the filler connector 3 and/or in the reducing agent tank 2 and/or in the pipe 24 which for conveying the reducing agent 2 to the pump 13,
ultrasonic transmitters and receivers 20 arranged in or on the reducing agent tank 1, and
filling level sensor or sensors 21 arranged in the reducing agent tank 1.

It is also conceivable to equip the exhaust gas post-treatment unit with a return line 29 that returns excessive quantity of supplied reducing agent 2 back to the reducing agent tank 1.

For this purpose, a return valve 28 is provided with which the quantity of the reducing agent 2, which has been fed back, can be set by the SCR control unit 15. Likewise, temperature sensors 17, which determine the temperature of the fed-back reducing agent 2 over the entire service life of the exhaust gas post-treatment unit, can also be arranged in the return line 29.

All these sensors supply their signals to the SCR control unit 15, which itself includes the electronic memory 25 in which all the supplied signals are recorded over the entire service life of the exhaust gas post-treatment unit. A long term analysis of the quality of the reducing agent 2 in the reducing agent tank 1 can be carried out by the data of the sensors recorded in the electronic memory 25, as a result of which the quality of the reducing agent 2 is known at any time and the exhaust gas purification can be adapted to the quality of the reducing agent 2. Furthermore, the control unit 16 of the internal combustion engine also receives information from the SCR control unit 15 with which the internal combustion engine can be actuated in accordance with the quality of the reducing agent. It is, for example, conceivable that, after pure water has been filled into the reducing agent tank 1, the quality of the reducing agent 2 has decreased to such an extent that exhaust gas post-treatment and the corresponding reduction of the NOx can no longer be sufficiently ensured. In such a case, on the one hand, an entry is made in a fault memory of the on-board diagnostic unit of the vehicle and, on the other hand, the internal combustion engine 6 can be operated, by the control unit 16 of the internal combustion engine, in an operating state in which as little NOx as possible is produced. The fact that this can reduce the maximum performance of the internal combustion engine 6 would be a possibly desirable consequence since the loss of performance of the internal combustion engine would force the vehicle driver to visit an appropriate repair workshop which would then ensure that a reducing agent 2 of sufficient quality is available in the reducing agent tank 1. As a result, environmentally appropriate post-treatment of the exhaust gas 23 in the exhaust section 7 would be ensured at all times.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A method for determining a state of a reducing agent used for exhaust gas post-treatment of exhaust gas generated by an internal combustion engine in a reducing agent tank, comprising:
determining and recording filling and extracting quantities of the reducing agent from the reducing agent tank by a filling level sensor over an entire service life of the exhaust gas post-treatment unit;
determining and recording a temperature of the reducing agent in the reducing agent tank by at least one temperature sensor over the entire service life of the exhaust gas post-treatment unit;
determining and recording a propagation speed of ultrasonic waves in the reducing agent with an ultrasonic transmitter and ultrasonic receiver; and
determining, in a control unit, the state of a reducing agent based at least in part on the filling quantity, the extracting quantity, the temperature, and the propagation speed of the reducing agent in the reducing agent tank.

8. The method as claimed in claim 7, further comprising:
determining a conductivity of the reducing agent by a first conductivity sensor; and
recording the conductivity in a memory.

9. The method as claimed in claim 8, further comprising:
determining a conductivity of a replenished reducing agent by a second conductivity sensor arranged in a filler connector of the reducing agent tank; and
recording the replenished reducing agent conductivity in the memory.

10. The method as claimed in claim 7, further comprising:
determining a NOx concentration in the exhaust gas of the internal combustion engine by at least one NOx sensor; and
recording the NOx concentration in the memory.

11. The method as claimed in claim 10, further comprising:
determining a theoretically necessary quantity of the reducing agent to completely remove the NOx concentration in exhaust gas;
comparing an actually required quantity of the reducing agent to completely remove the NOx concentration in the exhaust gas determined by the NOx sensor; and
recording at least one of the theoretically necessary quantity of the reducing agent and the actually required quantity of the reducing agent in the memory.

12. The method as claimed in claim 7, further comprising:
determining and recording in the memory at least one of whether, when, and for what time period the reducing agent is in a solid, liquid, or partially liquid physical state.

13. The method as claimed in claim 7, further comprising:
determining a conductivity of a replenished reducing agent by a conductivity sensor arranged in a filler connector of the reducing agent tank; and
recording the replenished reducing agent conductivity in a memory.

14. The method as claimed in claim 9, further comprising:
determining a NOx concentration in the exhaust gas of the internal combustion engine by at least one NOx sensor; and
recording the NOx concentration in the memory.

15. The method as claimed in claim 14, further comprising:
determining a theoretically necessary quantity of the reducing agent to completely remove the NOx concentration in exhaust gas;
comparing an actually required quantity of the reducing agent to completely remove the NOx concentration in the exhaust gas determined by the NOx sensor; and
recording at least one of the theoretically necessary quantity of the reducing agent and the actually required quantity of the reducing agent in the memory.

16. The method as claimed in claim 15, further comprising:
determining and recording in the memory at least one of whether, when, and for what time period the reducing agent is in a solid, liquid, or partially liquid physical state.
